(19) United States
(12) Patent Application Publication
(10) Pub. No.: US 2009/0001037 A1
(43) Pub. Date: Jan. 1, 2009

(54) COVER PANEL, TOOL THEREFOR, and METHODS THEREOF

(76) Inventor: John Wilcock, Cumming, GA (US)

Correspondence Address: PAPARELLA & ASSOCIATES, PLC, 3878 CASCADE RD. SE, GRAND RAPIDS, MI, 49546, US

(21) Appl. No.: 12/031,670

(22) Filed: Feb. 14, 2008

Related U.S. Application Data
(60) Provisional application No. 60/890,009, filed on Feb. 15, 2007.

(51) Int. Cl. A47G 29/00; A47B 13/08; B25B 27/00

(52) U.S. Cl. 211/119.003; 108/90; 81/488

(57) ABSTRACT

A cover panel for a shelf comprises a first surface including a first and a second edge, and a second surface including a third and a fourth edge, wherein the third edge is disposed adjacent the first edge of the first surface, and the second surface angularly extends from the first surface.

### BACKGROUND OF THE INVENTION

This application claims the benefit of the filing date of U.S. provisional application Ser. No. 60/890,009 entitled “SHELF COVER” which was filed on Feb. 15, 2007 and which is herein incorporated by reference.

The field of the invention generally relates to shelf coverings, and more particularly, to a covering for ventilated shelving, tools therefore and methods thereof.

Efficient and organized use of building space is extremely desirable, particularly with respect to storage or utility space in businesses, residential homes, and apartments. In particular, because of the limited or tight spaces in these locations, maximizing the amount of useable space is desirable. Likewise, providing ease in access and increased user convenience is important.

Ventilated shelving, including wire shelving, is now commonly used in both new and existing construction, as well as commercial and residential properties, and the shelving has now garnered acceptance as a useful storage medium. This is especially true in residential applications in closets, kitchen pantries, and laundry rooms. Further, at least in part, their popularity stems from their low cost, modularity, and ease of installation. For example, it is common today to use ventilated shelving (e.g., wire or plastic shelving and associated components) to construct storage units within closets.

Ventilated shelving is adaptable in that typical ventilated shelving not only varies in size and shape (e.g., different lengths and widths), and configuration (e.g., different wire mesh spacing), but may have connected thereto varied storage or attachment members.

Nevertheless, with the increased usage of these types of shelving units, problems have surfaced that are associated with this type of shelving. For example, because of the raised, typically parallel cross-bars of this type of shelving, soft articles such as clothing, when stored on the shelving, tend to develop or assume the unsightly pattern of the cross-bars, thereby requiring the wearer to iron or press the stored clothing before wearing the clothing.

Additionally, items that require storage in an upright position, once placed on the wire shelving, tend to fall over due to the lack of a fully supportive surface caused by the spacing between the cross-bars.

Yet another problem arises when the protective coating on the wire shelves begins to wear. The exposed surface, typically steel, tends to rust and thereby cause damage to the stored items. And, still further, whether or not the coating is still intact, this type of shelving is extremely difficult to thoroughly clean. This is one reason this style of shelving has not been accepted into environments that require thorough cleaning on a regular basis: for example, hospitals.

Yet still further, wire shelving has not been completely accepted into the residential or commercial industry due to its “commercial” appearance, as well as the inability to personalize or decorate the shelving, making it almost impossible to incorporate the shelving into the existing décor.

Accordingly, a need exists for novel systems and methods which have, among other advantages, increased utility, strength, variability, and adaptability, while simultaneously being easier to use and aesthetically pleasing. Therefore, a cover panel that solves the aforementioned disadvantages and having the aforementioned advantages is desired.

### SUMMARY OF THE PRESENT INVENTION

The aforementioned drawbacks and disadvantages of these former shelf covers have been identified and a solution is set forth herein by the inventive cover panel which includes a cover panel for a shelf comprising a first surface including a first and a second edge. Also included is a second surface including a third and a fourth edge, wherein the third edge is disposed adjacent the first edge of the first surface, and the second surface angularly extends from the first surface.

Another aspect of the present invention includes a cover for a ventilated shelf of the type comprising an overhanging flange, the cover comprising a first storage surface and an extension. The extension extends angularly from an edge of the first surface and is adapted to at least partially cover the overhanging flange of the ventilated shelf, wherein the first surface is adapted to rest on a storage surface of the ventilated shelf.

In another aspect of the present invention, a cover panel for a ventilated shelf of the type comprising a frontwardly overhanging flange includes a first generally flat surface including a first and a second edge. Further included is a second surface including a third and a fourth edge, wherein the third edge is disposed adjacent the first edge of the first surface, and the second surface extends generally perpendicular from the first surface. A third surface includes a fifth and a sixth edge, wherein the fifth edge is disposed adjacent the fourth edge of the second surface. The third surface extends generally perpendicular to the second surface. Further, a fourth surface including a seventh and an eighth edge is provided, wherein the seventh edge is disposed adjacent the sixth edge of the third surface. The fourth surface extends generally perpendicular to the third surface and the first surface is adapted to rest on a storage surface of a ventilated shelf.

And still in another aspect of the present invention, a method of installing a cover onto a ventilated shelf is disclosed, the method comprising: providing a ventilated shelf, the ventilated shelf including a support surface and a forwardly overhanging flange; providing a cover, the cover including: a first generally flat storage surface; and an extension, the extension extending angularly from an edge of the first surface; the extension adapted to at least partially cover the overhanging flange of the ventilated shelf; installing the cover by disposing the extension adjacent the overhanging flange of the ventilated shelf; scoring the cover along a determined length thereby creating a scored length; bending the cover along the scored length; separating the cover along the scored length thereby creating at least one usable cover piece; and seaming adjacent ends of two or more usable cover pieces in order to create a single unified cover piece.

And yet still in another aspect of the present invention a tool for assisting in the installation of a frangible cover onto a ventilated shelf is disclosed wherein the tool comprises a first planar surface, the first planar surface including a first and a second edge, wherein further the first edge is adapted to guide a scoring tool. A second surface is also included and is generally perpendicular to the first surface and longitudinally disposed along the second of edge first surface. Further, when the tool is disposed on a cover panel, the first edge is used to guide a scoring tool such that the scoring tool will scribe the cover panel thereby allowing the cover panel to be fractured along the scored line.

Other objects, advantages, and features of the invention will become apparent upon consideration of the following detailed description and accompanying drawings. The above brief description sets forth rather broadly the more important features of the present disclosure so that the detailed description that follows may be better understood, and so that the present contributions to the art may be better appreciated. There are, of course, additional features of the disclosures that will be described hereinafter which will form the subject matter of the claims.

In this respect, before explaining the preferred embodiment of the disclosure in detail, it is to be understood that the disclosure is not limited in its application to the details of the construction and the arrangement set forth in the following description or illustrated in the drawings. To with, the cover panel, tools and methods of the present disclosure are capable of other embodiments and of being practiced and carried out in various ways. Also, it is to be understood that the phraseology and terminology employed herein are for description and not limitation. Where specific dimensional and material specifications have been included or omitted from the specification or the claims, or both, it is to be understood that the same are not to be incorporated into the claims.

As such, those skilled in the art will appreciate that the conception, upon which this disclosure is based, may readily be used as a basis for designing other structures, methods, and systems for carrying out the several purposes of the present invention. It is important, therefore, that the claims are regarded as including such equivalent constructions as far as they do not depart from the spirit and scope of the present invention.

Further, the purpose of the Abstract is to enable the U.S. Patent and Trademark Office and the public generally, and especially the scientists, engineers, and practioners in the art who are not familiar with the patent or legal terms of phraseology, to learn quickly, from a cursory inspection, the nature of the technical disclosure of the application. Accordingly, the Abstract is intended to define neither the invention nor the application, which is only measured by the claims, nor is it intended to be limiting as to the scope of the invention in any way.

These and other objects, along with the various features, and structures that characterize the invention, are pointed out with particularity in the claims annexed to and forming a part of this disclosure. For a better understanding of the cover panel, tools and methods of the present disclosure, their advantages, and the specific objects attained by their uses, reference should be made to the accompanying drawings and descriptive matter in which there are illustrated and described the preferred embodiments of the invention.

As such, while embodiments of the cover panel, tools and methods are herein illustrated and described, it is to be appreciated that various changes, rearrangements and modifications may be made therein, without departing from the scope of the invention as defined by the claims.

### BRIEF DESCRIPTION OF THE DRAWINGS

As a compliment to the description and for better understanding of the specification presented herein, twenty pages of drawings are disclosed with an informative, but not limiting, intention.

FIG. 1 is an upper left perspective view of an embodiment of a cover panel of the present invention being installed on a ventilated shelf. The ventilated shelf is illustrated in hidden line and as such, forms no part of the invention;

FIG. 1A is a left side view of the cover panel of FIG. 1;

FIG. 2 is an upper right perspective view of the cover panel of FIG. 1;

FIG. 3 is an upper right perspective view of another embodiment of a cover panel of the present invention;

FIG. 4 is an upper right perspective view of yet another embodiment of a cover panel of the present invention;

FIG. 5 is an upper right perspective view of the cover panel of FIG. 1, including an embodiment of an assembly tool disposed thereon, in the process of being scored;

FIG. 6 is an upper right perspective view of the cover panel of FIG. 5, in the process of being scored further;

FIG. 7 is an upper right perspective view of the cover panel of FIGS. 5-6, after scoring, in the process of being separated;

FIG. 8 is an upper right perspective view of a pair of cover panels including a pair of seamable edges, abutingly disposed, in the process of seaming the pair of cover panels;

FIG. 9 is an upper right perspective view of the cover panel of FIG. 1, in the process of being cut with a pair of scissors;

FIG. 10 is an upper right perspective view of another embodiment of an assembly tool;

FIG. 11 is an upper right perspective view of another embodiment of a cover panel;

FIG. 12 is a rear perspective view of another embodiment of a cover panel;

FIG. 13 is an upper right perspective view of another embodiment of a cover panel;

FIG. 14 is an upper right perspective view of another embodiment of a cover panel;

FIG. 15 is an upper right perspective view of another embodiment of a cover panel;

FIG. 16 is an upper left perspective view of another embodiment of a cover panel;

FIG. 17 is an upper left perspective view of another embodiment of a cover panel;

FIG. 18 is an upper left perspective view of another embodiment of a cover panel;

FIG. 19 is an upper left perspective view of another embodiment of a cover panel;

FIG. 20 is an upper right perspective view of another embodiment of a cover panel;

FIG. 21 is an upper right perspective view of another embodiment of a cover panel with accessories;

FIG. 22 is an upper right perspective view of another embodiment of a cover panel.

### DETAILED DESCRIPTION OF THE PREFERRED EMBODIMENT

The best mode for carrying out the invention is presented in terms of the preferred embodiment, wherein similar referenced characters designate corresponding features throughout the several figures of the drawings.

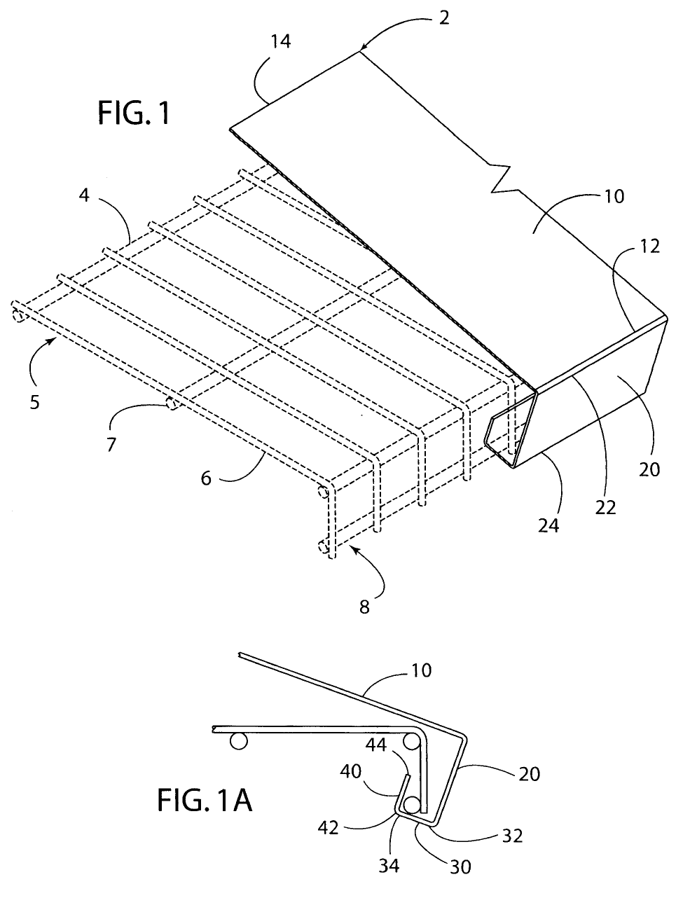

For purposes of description herein, the terms “upper”, “lower”, “right”, “left”, “rear”, “front”, “vertical”, “horizontal”, and derivatives thereof, shall relate to the invention as oriented in FIG. 1. However, it is to be understood that the invention may assume various alternative orientations, except where expressly specified to the contrary. It is also to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

Reference will now be made in detail to the present preferred embodiments of the invention, examples of which are illustrated in the accompanying drawings. Wherever possible, these same referenced numerals will be used throughout the drawings to refer to the same or like parts. Like features between the various embodiments utilize similar numerical designations. Where appropriate, the various similar features have been further differentiated by an alphanumeric designation, wherein the corresponding alphabetic designator has been changed. Further, the dimensions illustrated in the drawings (if provided) are included for purposes of example only and are not intended to limit the scope of the present invention. Additionally, particular details in the drawings which are illustrated in hidden or dashed lines are to be considered as forming no part of the present invention.

Wire shelving is known in the art and is typically metal shelving comprising one or more diameters of coated metal rod, supported along its length by a plurality of support rods. Typically, these metal shelves also comprise a frontwardly overhanging support flange. However, ventilated shelving is a broader term and is meant to include wire shelving, and as used herein, ventilated shelving is to be given a broader meaning and not meant to be restricted in meaning to wire shelving alone. As such, ventilated shelving is meant to include any shelving with openings therein regardless of the material from which it is fabricated and regardless of whether or not it is fabricated from a “wire.” For example only, ventilated shelving can include shelving that has been fabricated from any material, metal or other (i.e. plastic), and fabricated from any style of material, including rods, sheets, bars, stampings, or the like. Further, the shelving will typically, though not necessarily, comprises a support flange extending from the main support surface. Of course, this is not meant to be limiting in any manner and ventilated shelving may take on numerous configurations, and may be used for numerous purposes as is generally known within the art.

In a broader sense, ventilated shelving is now commonly used in both new and existing construction, as well as commercial and residential properties, and the shelving has now garnered acceptance as a useful storage medium. This is especially true in residential applications such as closets, kitchen pantries, and laundry rooms. At least in part, their popularity stems from their low cost, modularity, and ease of installation.

It is common today to use ventilated shelving to construct storage units within closets. Typical ventilated shelving not only varies in size (e.g., different lengths and widths), but also varies in configuration (e.g., different wire mesh spacing).

Nevertheless, with the increased usage of these types of shelving units, problems have surfaced that are associated with this particular type of (ventilated) shelving. For example, because of the raised, typically parallel cross-bars of this type of shelving, soft article such as clothing, when stored on the shelving, tend to develop or assume the unsightly pattern of the cross-bars, thereby requiring the wearer to iron or press the stored clothing before wearing the clothing.

Additionally, items that require storage in an upright position, once placed on the wire shelving, tend to fall over due to the lack of a fully supportive surface caused by the spacing between the cross-bars.

Yet another problem arises when the protective coating on the wire shelves begins to wear. The exposed surface, typically steel, tends to rust thereby causing damage to the stored items. And, still further, whether or not the coating is still intact, this type of shelving is extremely difficult to thoroughly clean. This is one reason this style of shelving has not been accepted into environments that require thorough cleaning on a regular basis: for example, hospitals.

Yet still further, wire shelving has not been completely accepted into the residential or commercial industry due to its “commercial” appearance, as well as the inability to personalize or decorate the shelving making it almost impossible to incorporate the shelving into the surrounding décor.

Accordingly, a need exists for novel systems and methods which have, among other advantages, increased utility, strength, variability, and adaptability, while simultaneously being easier to use and aesthetically pleasing. Therefore, a cover panel that solves the aforementioned disadvantages and having the aforementioned advantages disclosed herein.

The disadvantages and drawbacks of the prior art are overcome through the cover panel of the present invention, wherein one preferred embodiment is disclosed in FIGS. 1-7. Referring now to FIG. 1, there is shown a cover panel 2 for a shelf 4. In a first embodiment, cover panel 2 includes a first surface 10 further including a first edge 12 and a second edge 14. Cover panel 2 also includes a second surface 20 which further includes a third edge 22 and a fourth edge 24, wherein third edge 22 is disposed adjacent first edge 12 of first surface 10. Second surface 20 angularly extends from first surface 10. A third surface 30 (See FIG. 1A) includes a fifth edge 32 and a sixth edge 34, wherein fifth edge 32 is disposed adjacent fourth edge 24 of second surface 20. Third surface 30 angularly extends from second surface 20. Finally, in this particular embodiment, a fourth surface 40 is included and comprises a seventh edge 42 and an eighth edge 44. Seventh edge 42 is disposed adjacent sixth edge 34 of third surface 30. Fourth surface 40 angularly extends from third surface 30.

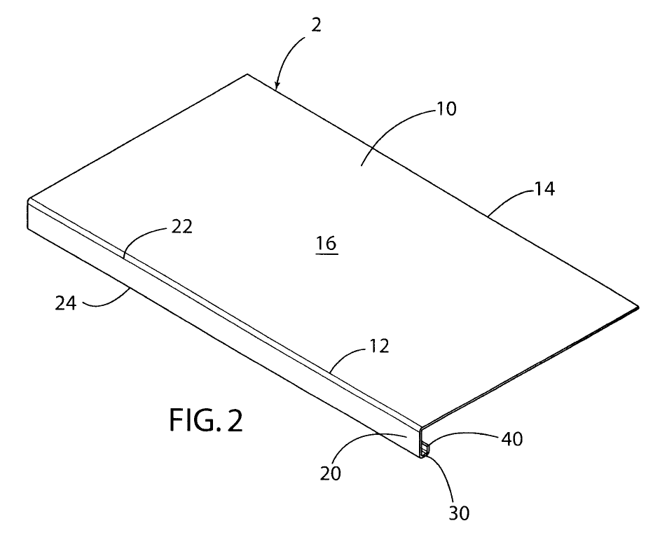

Referring to FIG. 2, cover panel 2 includes first surface 10. In this embodiment, first surface 10 comprises a generally flat surface 10 including first edge 12 and second edge 14 that run lengthwise along the panels longitudinal axis. When installed on a ventilated shelf 4 (see FIG. 1), second edge 14 is typically the rear edge, and first edge 12 is typically the front edge, while first surface 10 generally rests on a support surface 5 of ventilated shelving 4. In one embodiment (see FIG. 1), ventilated shelving 4 includes a support surface 5 which comprises a plurality of smaller support wires or rods 6 generally supported by structural wires or rods 7. First surface 10 also includes support surface 16.

Second surface 20 may also comprise a generally flat support surface and, in this embodiment, is generally perpendicular to first surface 10, wherein longitudinal edge 22 of second surface 20 is disposed adjacent longitudinal edge 12 of first surface 10.

As best illustrated in FIG. 1A, third surface 30 may comprise a generally flat surface and third surface 30, in this embodiment, is generally perpendicular to second surface 20, wherein longitudinal edge 32 of third surface 30 is disposed adjacent longitudinal edge 24 of second surface 20, and further, generally parallel to first surface 10. In yet another embodiment (not shown) third surface 30 may be arcuate, for example, to better conform to the rounded configuration of structural wire or rods 7 of ventilated shelving 4.

Fourth surface 40 may again comprise a generally flat surface and fourth surface 40, in this embodiment, is generally perpendicular to third surface 30, wherein longitudinal edge 42 of fourth surface 40 is disposed adjacent longitudinal edge 34 of third surface 30, and further, generally parallel to second surface 20 and generally perpendicular to first surface 10.

The specific configurations and features of cover panel 2 may vary according to specific requirements. In the preferred embodiment, cover panel 2 is generally rectangular in shape and is fabricated in a one-piece configuration from Polyvinyl Chloride (PVC) having an approximate thickness of 0.040″ (inch), wherein first, second, third and fourth surfaces 10, 20, 30, and 40, respectively, are formed through an extrusion process. However, the shape of cover panel 2 may vary according to specific requirements and need not be rectangular in configuration. Further, although one preferred embodiment of cover panel 2 is fabricated from a plastic utilizing extrusion techniques, other ridged and semi-ridged materials and fabrication techniques may be used. For example, cover panel 2 may be molded from a plastic material, or bent from a metal material. In addition, although this particular embodiment of cover panel 2 is fabricated into a one-piece configuration, multiple pieces can be utilized, and assembled by various means such as fasteners, welding, and other techniques well known in the art.

Further yet, it is envisioned that the style or configuration of cover panel 2 can be varied and numerous other configurations can be fabricated. For example, cover panel 2 may be colored or multicolored; various decorative appearances may either be formed or retained on the panel: for example a wood appearance may be molded or otherwise imprinted onto cover panel 2; further, upstanding edges may be utilized for either support or retention: for example an upstanding edge may be used on either edge 12 or 14 of first surface 10 for structural rigidity and/or to prevent items disposed on surface 16 from falling off; Still further yet, the various surfaces 10, 20, 30, and 40 may be configured in any geometry to suit the particular needs: for example these surface could be rounded for fit or aesthetics; of course, various finishes may also be applied to surfaces 10, 20, 30, and 40: for example, surface 10 may have applied to it a gripping material for better retention of articles disposed thereon; Yet further, it is envisioned that various advertisements, endorsement, and the like may be applied, molded, imprinted, or otherwise affixed to panel 2 in order to promote various activities and/or organizations.

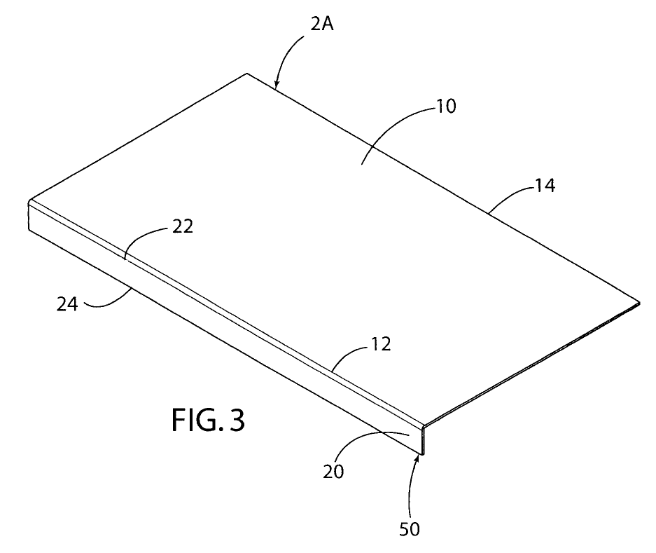

Referring now to FIG. 3, another embodiment is illustrated wherein cover panel 2A comprises a first surface 10 further including a first edge 12 and a second edge 14. Cover panel 2A also includes an extension 50 longitudinally disposed adjacent edge 12. In this particular embodiment, extension 50 includes second surface 20 which further includes a third edge 22 and a fourth edge 24, wherein third edge 22 is disposed adjacent first edge 12 of first surface 10. Extension 50 angularly extends from first surface 10. In this particular embodiment, extension 50 extends generally perpendicular from first surface 10. Further, in this particular configuration, extension 50 will at least partially cover overhang 8 of shelf 4.

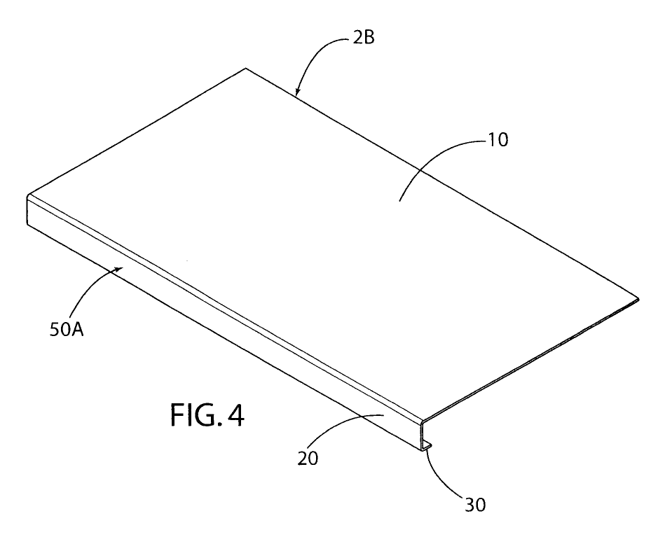

Referring now to FIG. 4, yet another embodiment is illustrated wherein cover panel 2B comprises a first surface 10 further including a first edge 12 and a second edge 14. Cover panel 2B also includes an L-shaped extension 50A longitudinally disposed adjacent edge 12. In this particular embodiment, extension 50A includes second surface 20 which further includes a third edge 22 and a fourth edge 24, wherein third edge 22 is disposed adjacent first edge 12 of first surface 10. A third surface 30 includes a fifth edge 32 and a sixth edge 34, wherein fifth edge 32 is disposed adjacent fourth edge 24 of second surface 20. Third surface 30 angularly extends from second surface 20. In this particular embodiment, third surface 30 extends generally perpendicular from second surface 20 and again, extension 50A angularly extends from first surface 10 which, in this particular embodiment, extends generally perpendicular from first surface 10.

Of course, as described previously, extension 50A could also be fabricated into a J-shaped configuration (see generally FIG. 1) as described previously. In the L-shaped configuration, extension 50A will at least partially cover overhang 8, while in the J-shaped configuration overhang 8 will be, at least partially, wrapped, enclosed or encapsulated.

The specific configurations and features of cover panels 2A and 2B may vary according to specific requirements and are similar in manufacturing as that described with regard to embodiment 2.

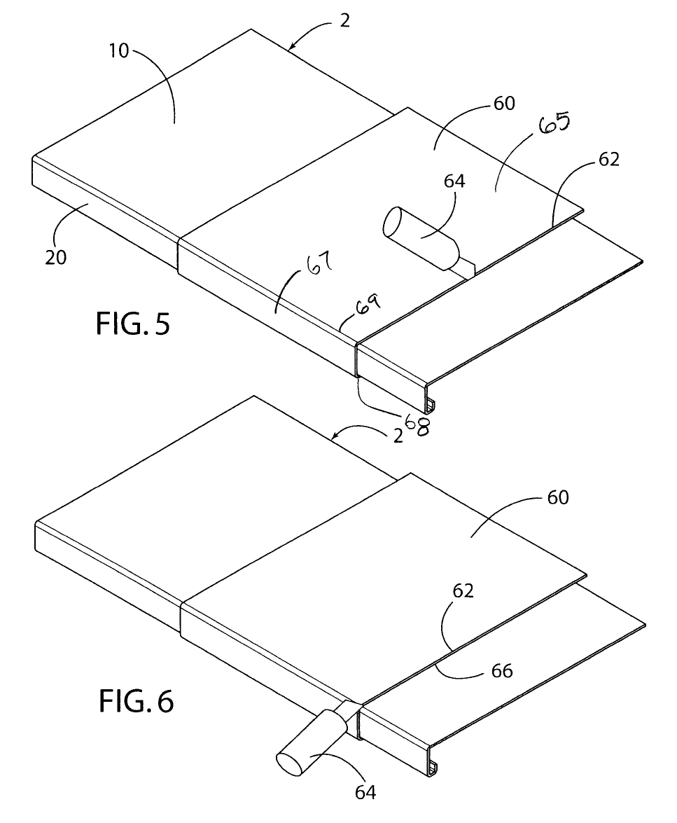

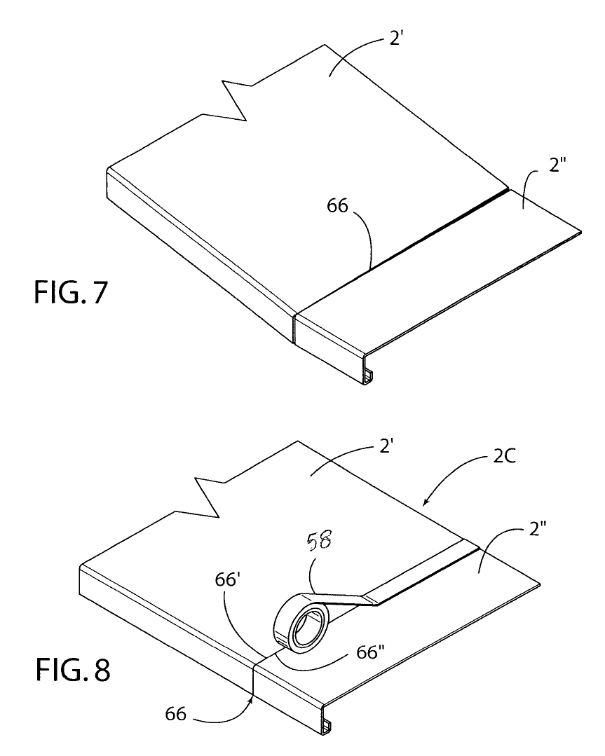

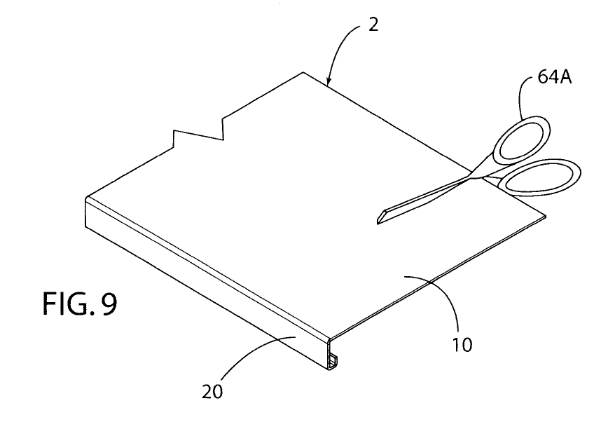

Referring now to FIGS. 5-8, there is shown an exemplary embodiment of a process for adjusting the dimensions of a cover panel 2. For example, to shorten the longitudinal length of a panel 2, an assembly tool 60 including a first surface 65 having a first edge 62 is positioned at the desired location and firmly held in place. The assembly tool further includes a second surface 67 angularly and longitudinally disposed with surface 65, along second edge 69, and may also include a third surface 68 angularly and longitudinally disposed with surface 67 along an edge opposite edge 69. In one preferred embodiment, surface 67 is perpendicular to first surface 65, and surface 68 is parallel to surface 65. In this manner tool 60 closely conforms to cover panel 2 and is able to slide therealong. A scoring, cutting tool, or other sharp instrument 64 is then used to scribe, score or cut cover panel 2 at the desire location along at least first surface 10 (FIG. 5) and preferably, in addition thereto, along second surface 20 (FIG. 6). The cover panel 2 is then bent (FIG. 7) along the resultant score line or cut 66 in order to separate panel 2 into two parts 2′ and 2″, thereby allowing the panel system 2 to be easily and readily configured into any size required by the end user. In this embodiment, panel 2 is either scorable, in that it can be scored and then bent (i.e. frangible) to separate the individual pieces, or it simply may be cut all the way through utilizing various tools known in the art.

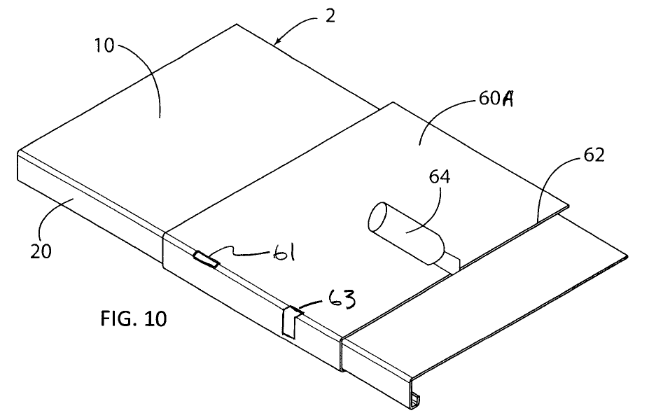

Yet another feature of cover panel system 2 is its ability to be seamed as shown in FIG. 8. Due to the configuration and similarity of cover panels 2, a pair of panels 2′ and 2″ may be adjacently and abutingly disposed along edges 66′ and 66.″ The resultant edge 66 is uniform in height and appearance and when seamed with, for example only, a tape 58, the result is a continuous, single, unified cover panel 2C. Thus, panel system 2 has the advantages of being easily and readily configured into any size and/or configuration required by the end user, as well reducing or minimizing the waste or amount of shelving required to be thrown away due to being improperly dimensioned.

FIG. 9 illustrates another method to shorten the longitudinal length of a panel 2, whereby a pair of scissors 64A is used to cut cover panel 2 at the desire location.

FIG. 10 illustrates another embodiment of the assembly tool 60A and includes notches or openings 61 and 63. These openings are used to assist the installer in cutting openings on cover panel 2 where, in some cases, these openings are required for support brackets, bracketry and the like in supporting the wire shelving to the associated wall surface, as is generally known in the art.

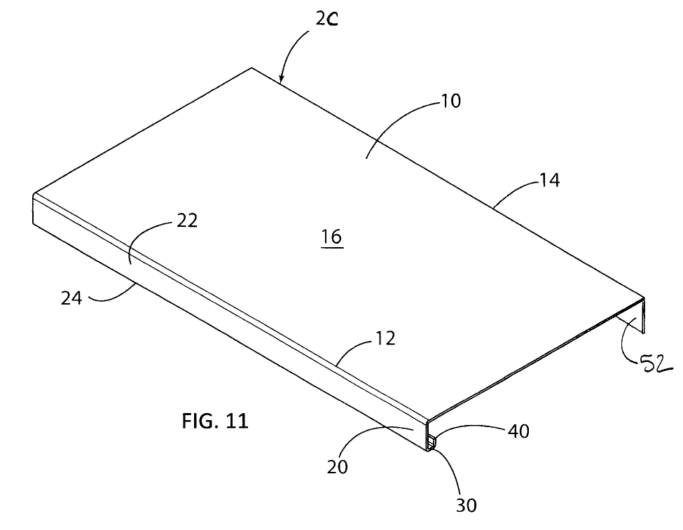

FIG. 11 illustrates another embodiment of cover panel 2C. In this embodiment an extension 52 is longitudinally disposed adjacent edge 14. Rear extension 52 angularly extends from first surface 10, in a similar manner as front extension 50 in cover panel 2A, and again in this particular embodiment, extends generally perpendicular from first surface 10. Rear extension 52 may be useful, for example, in assisting to retain cover panel 2 onto ventilated shelving 4, whereby extension 52 is inserted behind the rear portion of the ventilated shelving 4 (and adjacent the installation or wall surface) and helps prevent movement of cover panel 2 in a forward direction. As illustrated, rear extension 52 may be used in conjunction with, either alone or in combination, surfaces 20, 30, and 40.

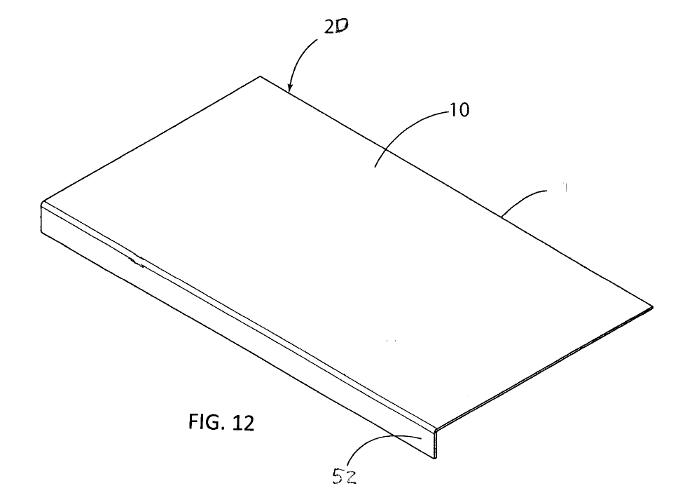

Of course, as illustrated in FIG. 12, extension 52 may used alone, i.e. without any front extension. In this manner extension 52 can be used on ventilated shelving which does not include an overhanging portion 8: and yet, even without overhanging portion 8 or surfaces 20, 30 and/or 40 to aid in the retention of the cover panel, extension 52 will act to retain cover panel 2D onto the ventilated shelving. Alternatively, even if the ventilated shelving comprises an overhanging portion 8, it may otherwise be desired to use cover panel 2D in place of the other embodiments when it is desired to retain full access to the overhang 8 as in, for example, to hang clothes thereon as is generally known in the art, while still requiring some form of cover panel retention.

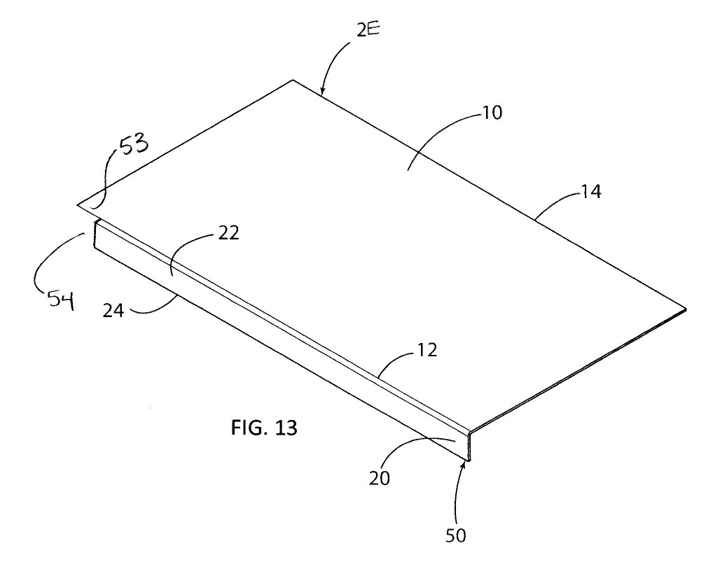

FIG. 13 illustrates another embodiment of cover panel 2E. In this embodiment a notch 54 is disposed adjacent an end 53. The notch, for example, may be used to allow clearance for support brackets, bracketry and the like in supporting the wire shelving to the associated wall surface, as is generally known in the art. It is envisioned that the various notches, openings, and cut-outs may be pre-formed onto the various cover panels such that the installer need only “knock-out” the preformed features, as is generally known in the art.

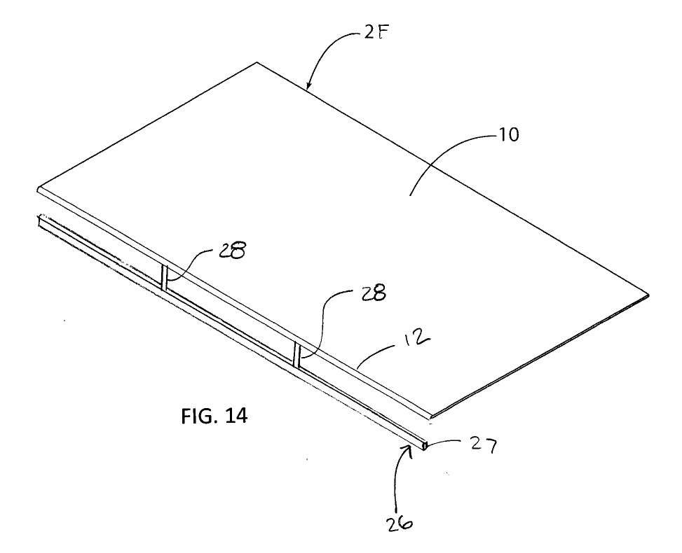

FIG. 14 illustrates another embodiment of cover panel 2F. In this embodiment a hanger bracket 26 is positioned or otherwise disposed angularly adjacent to first edge 12. In this embodiment, hangers, for example clothes hangers, may be supported and otherwise organized along the hanging rod 27. Rod 27 is angularly connected to and suspends from first surface 10 through support rods 28. Of course, extension 52 (not shown) could be included in this embodiment to assist with the retention of cover panel 2F onto the ventilated shelving.

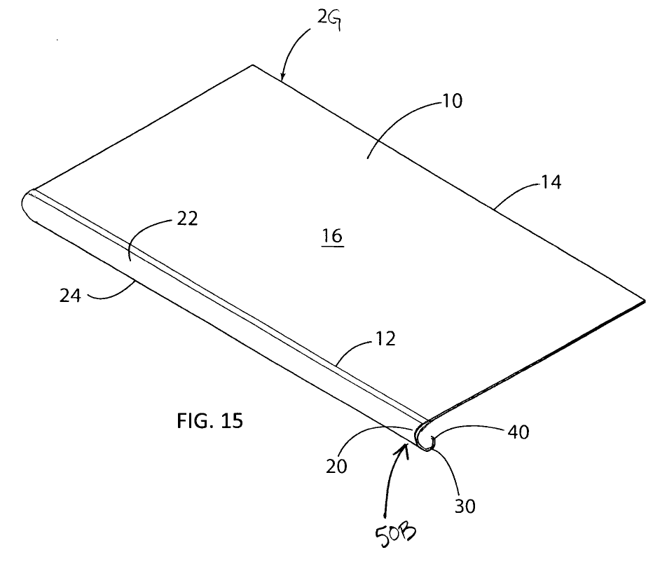

FIG. 15 illustrates another embodiment of cover panel 2G. In this embodiment second surface 20 and third surface 30 are rounded to provide a curved front extension 50B.

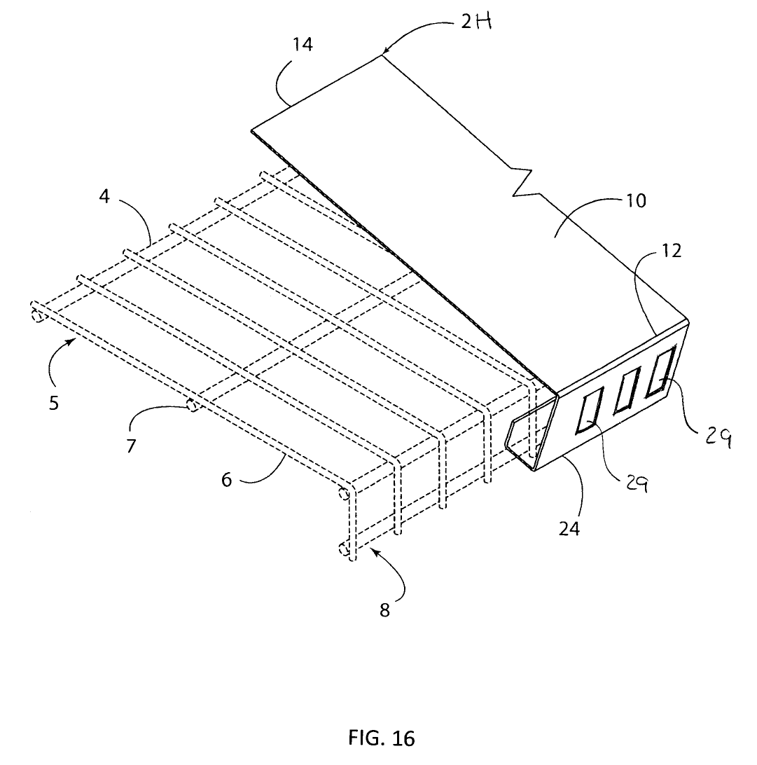

FIG. 16 illustrates another embodiment of cover panel 2H. In this embodiment second surface 20 includes one or more openings 29. Openings 29 may be used, for example only, to provide access to the overhanging portion 8 of ventilated shelving 4 (i.e. to provide access to overhanging portion 8 for the purpose of hanging clothes thereon). Of course, openings 29 may be utilized, directly, for hanging clothes thereon.

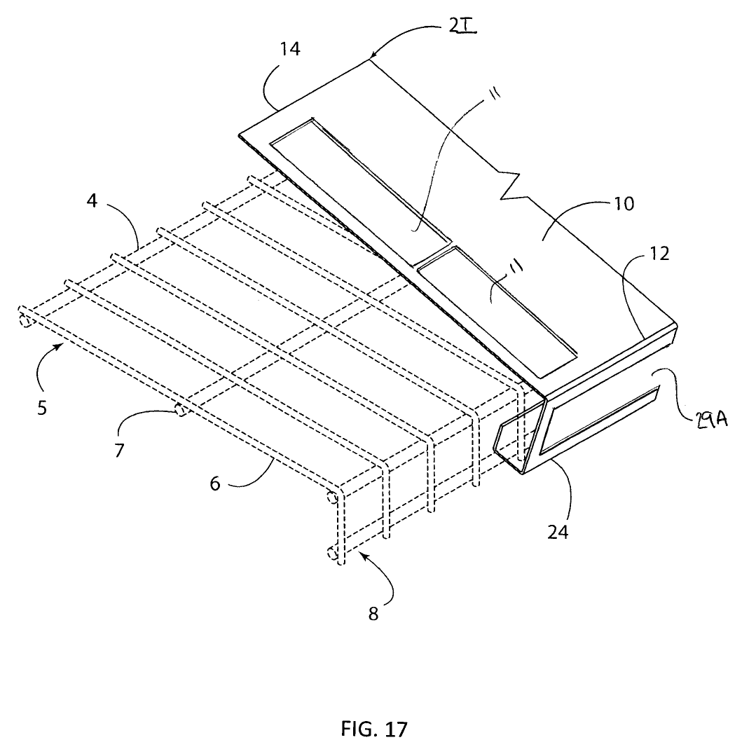

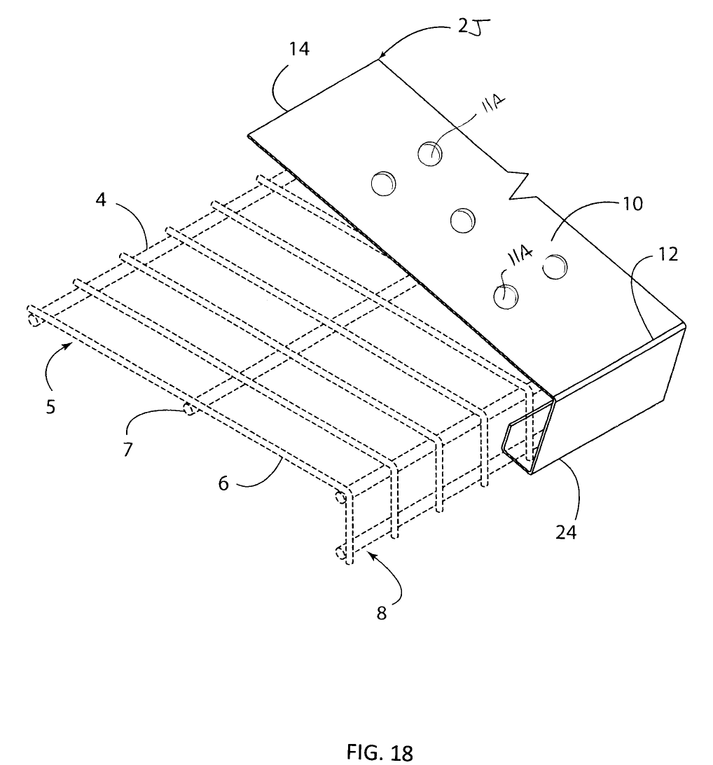

FIG. 17 depicts another embodiment of cover panel 2I and includes a second embodiment of an opening 29A further including, typically, a single longitudinal opening which may be used as described above with regard to openings 29. Also illustrated in FIG. 17 are openings 11 disposed with first surface 10. These openings have numerous uses, all known in the art, including draining, ventilation, and the like. Openings 11 may be optimized (i.e. size) for the particular requirements of the end user and also function to reduce the over material costs of the cover panel, as well as assist with the transmission of light through and to the lower shelving units. Of course, light transmission may also be increased by utilizing clear or semi-clear materials. FIG. 18 depicts yet another embodiment 2J of the cover panel and includes a second embodiment of openings 11A.

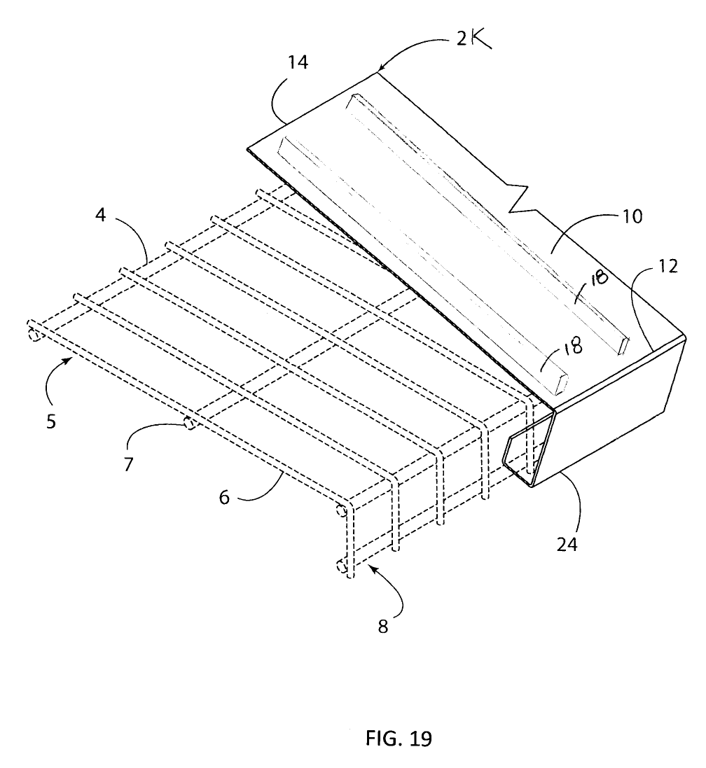

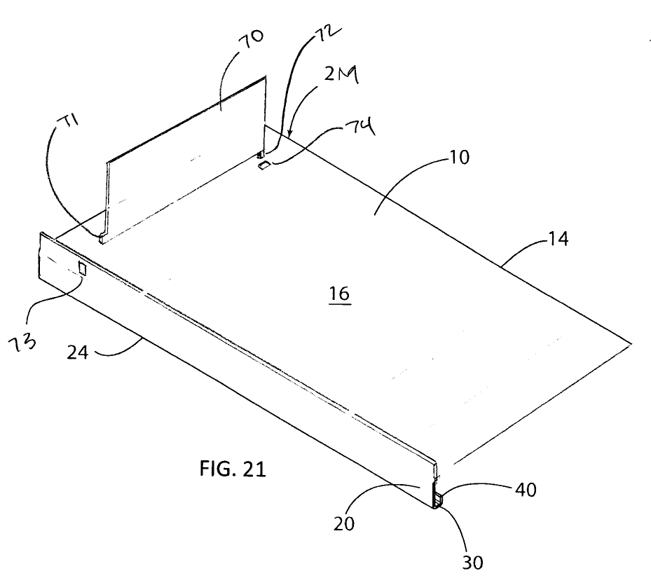

FIG. 19 depicts still another embodiment 2K of the cover panel and includes one or more guides 18. Guides 18 may be used, for example, for assisting with the organization of stored items on cover panel 2K. These guides may be configured in numerous shapes, sizes, quantities, and the like as the particular requirements dictate. In the illustrated figure, two top guides 18 are shown as function to create a slot or row that items can be organized and retained within. For example, by utilizing relatively low height guides 18, canned goods can be retained with the confines of the two guides. However, if the guides 18 were to be tall in nature, files could then be disposed therebetween. Further yet, these guides can be made to be positionable, movable, and/or replaceable by means known in the art, thereby allowing for greater adaptability (see FIG. 21).

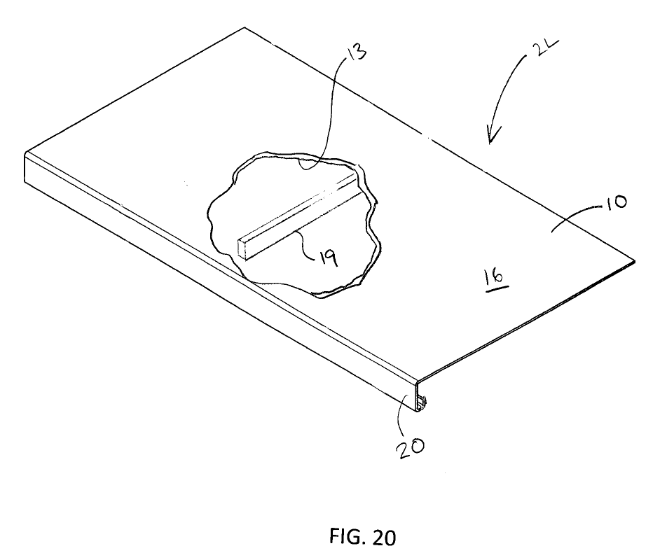

FIG. 20 depicts yet another embodiment 2L of the cover panel and includes one or more bottom guides 19 disposed adjacent bottom surface 13 of first surface 10. Guides 19 may be used, for example, for assisting with the retention of cover panel 2L onto the ventilated shelving and may be configured in size and shape to fit between support wires 6 and/or structural wires 7 of ventilated shelving 4. In this manner, with cover panel 2L installed thereon, the panel will resist being shifted in a longitudinal direction because of guides 19 abutting support wires 6.

FIG. 21 depicts still another embodiment 2N of the cover panel and includes one or more label slot 21 formed or otherwise disposed within second surface 20 as illustrated. Numerous sizes and configurations of label slot 21 can be fabricated into surface 20 as the particular requirements may dictate and as are known in the art.

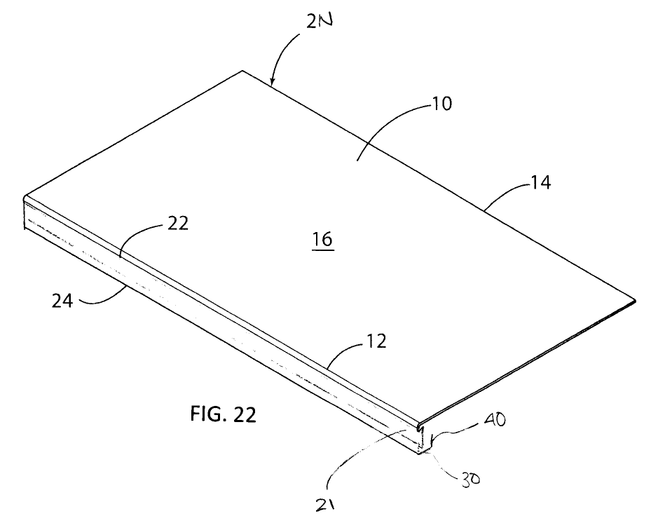

FIG. 22 depicts still another embodiment 2M of the cover panel and includes one or more positionable separators 70. Separators 70 may be configured and replacably positionable in any manner known in the art. For example, separators 70 may have tabs 71 and 72 which would fit into openings 73 and 74, respectively. As such, these separators may be positioned, moved, and/or replaced thereby allowing for maximum configurability and greater adaptability for storage.

Additionally, it is envisioned that numerous other features may be added to cover panel 2. For example, various aesthetic features like color, texture, and graphics may be applied. Additionally, features such as drawers and drawer guides, lazy-Susan's, and other shelving and storage accessories can be included, affixed, or otherwise disposed on cover panel 2 to further increase its flexibility.

A unique feature of cover panel 2 is its ability to cover part, substantially all, or entirely, support surface 5 of wire shelf 4. As shelving varies between manufacturers, the ability to allow for changes in the configuration of cover panel 2 creates a highly adaptable panel. In addition, because the edges allow for seaming, multiple panels 2 can be adjoined in order to continuously cover multiple adjoining wire shelves 4. In this manner, any length, and indeed an infinite length of uninterrupted and continuous covering can be achieved, whereby the resultant continuous surface is, after seaming, uninterrupted and continuous, without ridges, bumps, or other obstacles. Hence, this system offers the ability to cover any portion of the shelf support surface 5, regardless of the length.

Yet another unique feature of cover panel 2 is its ability, when utilizing either the fourth surface 40 or the J-shaped extension, to prevent the panel from being accidentally removed or accidentally falling off. This is accomplished by dimensioning, for example, the height of fourth surface 40, such that when cover 2 is disposed on ventilated shelf 4 and first surface 10 is rotated upwardly off support surface 5 of ventilated shelf 4, eighth edge 44 interferes with overhanging flange 8 thereby restricting the ability of the cover from being removed and assisting in the retention of the cover on ventilated shelf 4. For example, fourth surface 40 may include a length dimensioned such that when cover 2 is disposed on a horizontal ventilated shelf 4, and cover 2 is rotated upwardly, for example, 45 degree or less, eighth edge 44 may touch support wires or rods 6 of the overhanging flange, thereby restricting the ability of the cover from being removed and assisting in the retention of the cover on the ventilated shelf 4.

Further yet, when cover panel 2 includes either fourth surface 40 or the J-shaped extension, panel 2 can be dimensioned so as to make audible sounds when being installed onto or removed from the ventilated shelving. This is accomplished by having fourth surface 40 or the J-shaped extension interact with overhang 8, as described below.

Further, a process of installation for cover panel 2 has been herein described. However, this process does not, necessarily, have a liner sequence of events. Therefore, it is to be understood that various modifications may be made to the sequences, methods, orientations, and the like without departing from the inventive concept and that the description contained herein is merely a preferred embodiment and hence, not meant to be limiting unless stated otherwise.

Advantageously, the cover panel of the present invention is efficiently fabricated and elegantly designed while being engineered to be adaptable, easily installed and allow for varied configurations. Consequently, the embodiments of the preferred invention disclosed herein reveal a cover panel which is uniquely and efficiently designed. Additionally, the cover panel of the present invention is aesthetically appealing.

The solutions offered by the invention disclosed herein have thus been attained in an economical, practical, and facile manner. To whit, a novel cover panel which is cost effective, easily installed, strong, and aesthetically pleasing has been invented. While preferred embodiments and example configurations of the inventions have been herein illustrated, shown, and described, it is to be appreciated that various changes, rearrangements, and modifications may be made therein, without departing from the scope of the invention as defined by the claims. It is intended that the specific embodiments and configurations disclosed herein are illustrative of the preferred and best modes for practicing the invention, and should not be interpreted as limitations on the scope of the invention as defined by the claims, and it is to appreciated that various changes, rearrangements, and modifications may be made therein, without departing from the scope of the invention as defined by the claims.

The invention claimed is:

1. A cover panel for a shelf comprising:
a first surface including a first and a second edge;
a second surface including a third and a fourth edge, the third edge disposed adjacent the first edge of the first surface, the second surface angularly extending from the first surface.

2. The cover panel according to claim 1 further comprising:
a third surface including a fifth and a sixth edge, the fifth edge disposed adjacent the fourth edge of the second surface, the third surface angularly extending from the second surface.

3. The cover panel according to claim 2 further comprising:
a fourth surface including a seventh and an eighth edge, the seventh edge disposed adjacent the sixth edge of the third surface, the fourth surface angularly extending from the third surface.

4. The cover panel according to claim 1 wherein:
the second surface is disposed generally perpendicular to the first surface.

5. The cover panel according to claim 2 wherein:
the second surface is disposed generally perpendicular to the first surface; and
the third surface is disposed generally perpendicular to the second surface and generally parallel to the first surface.

6. The cover panel according to claim 3 wherein:
the second surface is disposed generally perpendicular to the first surface;
the third surface is disposed generally perpendicular to the second surface and generally parallel to the first surface; and
the fourth surface is disposed generally perpendicular to the third surface, generally parallel to the second surface, and generally perpendicular to the first surface.

7. The cover panel of claim 1 wherein the first and second surfaces are scorable along a length thereof;
whereby after the first and second surfaces are scored, the first and second surfaces are frangible along the scored length.

8. A cover for a ventilated shelf of the type comprising an overhanging flange, the cover comprising:
a first storage surface; and
an extension;
the extension extending angularly from an edge of the first surface;
the extension adapted to at least partially cover the overhanging flange of the ventilated shelf; and
wherein the first surface is adapted to rest on a storage surface of the ventilated shelf.

9. The cover of claim 8 wherein:
the extension extends generally perpendicularly to the first surface.

10. The cover of claim 9 wherein:
the extension is L-shaped.

11. The cover of claim 9 wherein:
the extension is J-shaped.

12. The cover of claim 8 wherein:
the cover further includes a first seamable edge;
the seamable edge adapted to be joined with a second seamable edge from a second cover abutingly disposed thereto; and
wherein when the first and the second seamable edges are abutingly disposed and seamed, the adjacent adjoining first surfaces create a single unified cover piece.

13. A cover panel for a ventilated shelf of the type comprising a frontwardly overhanging flange, the panel comprising:
a first generally flat surface including a first and a second edge;
a second surface including a third and a fourth edge, the third edge disposed adjacent the first edge of the first surface, the second surface extending generally perpendicular from the first surface;
a third surface including a fifth and a sixth edge, the fifth edge disposed adjacent the fourth edge of the second surface, the third surface extending generally perpendicular to the second surface; and
a fourth surface including a seventh and an eighth edge, the seventh edge disposed adjacent the sixth edge of the third surface, the fourth surface extending generally perpendicular to the third surface;
wherein the first surface is adapted to rest on a storage surface of a ventilated shelf.

14. The cover panel of claim 13 wherein at least the first and second surfaces are scorable along a length thereof; and
whereby after the first and second surfaces are scored, the first and second surfaces are frangible along the scored length.

15. The cover panel of claim 13 wherein:
the first surface is dimensioned so as to cover substantially all of the support surface of the ventilated shelf.

16. The cover panel of claim 13 wherein:
the first surface is dimensioned so as to extend the entire length of the support surface of the ventilated shelf.

17. The cover panel of claim 13 wherein:
the third surface is arcuate.

18. The cover panel of claim 13 further including:
at least one seamable edge.

19. The cover panel of claim 13 wherein:
the fourth surface is dimensioned so that, when the cover panel is disposed on the ventilated shelf and the first surface is rotated upwardly off the support surface of the ventilated shelf, the eighth edge interferes with the overhanging flange thereby restricting the ability of the cover panel from being removed and assisting in the retention of the cover panel on the ventilated shelf.

20. The cover panel of claim 13 wherein:
the fourth surface includes a length dimensioned such that when the cover panel is disposed on a horizontal ventilated shelf, and the cover panel is rotated upwardly 45 degree or less, the seventh edge touches the overhanging flange;
thereby restricting the ability of the cover panel from being removed and assisting in the retention of the cover panel on the ventilated shelf.

21. The cover panel of claim 1 wherein:
the first surface includes openings disposed therein.

22. The cover panel of claim 1 wherein:
the second surface includes openings disposed therein.

23. The cover panel of claim 1 wherein:
the second surface includes a hanging rod.

24. The cover panel of claim 1 wherein:
the first surface includes guides disposed thereon.

25. The cover panel of claim 24 wherein:
the guides are positionable.

26. The cover panel of claim 1 wherein:
a bottom surface includes guides disposed thereon.

27. The cover panel of claim 1 further including:
at least one separator disposed on the first surface.

28. The cover panel of claim 27 wherein:
the separator is positionable.

29. The cover panel of claim 1 wherein:
the second surface includes a label slot formed therein.

30. A method of installing a cover onto a ventilated shelf, the method comprising:
providing a ventilated shelf, the ventilated shelf including a support surface and overhanging flange;
providing a cover, the cover including;
a first generally flat storage surface; and
an extension;
the extension extending angularly from an edge of the first surface;
the extension adapted to at least partially cover the overhanging flange of the ventilated shelf;
installing the cover by disposing the extension adjacent the overhanging flange of the ventilated shelf.

31. The method of installing a cover of claim 30, the method further comprising:
determining the length of a ventilated shelf;
transferring the determined length of the ventilated shelf to be covered to the cover;
scoring the cover along the determined length thereby creating a scored length;
bending the cover along the scored length;
separating the cover along the scored length thereby creating at least one usable cover piece.

32. The method of installing a cover of claim 31, the method further comprising:
seaming adjacent ends of two or more usable cover pieces in order to create a single unified cover piece.

33. A tool for assisting in the installation of a frangible cover onto a ventilated shelf, the tool comprising:
a first planar surface, the first planar surface includes a first and a second edge, the first edge adapted to guide a scoring tool;
a second surface, the second surface generally perpendicular to the first surface and longitudinally disposed along the second of edge first surface;
wherein when the tool is disposed on a cover panel, the first edge is used to guide a scoring tool such that the scoring tool will scribe the cover panel thereby allowing the cover panel to be fractured along the scored line.

34. The cover panel of claim 13 wherein:
the second and fourth surface are spaced so as to create an audible sound when installed onto an overhanging flange of a ventilated shelf.
